(19) United States
(12) Patent Application Publication
(10) Pub. No.: US 2007/0267403 A1
(43) Pub. Date: Nov. 22, 2007

(54) Electrical Appliance with Cylindrical Receptacles

(76) Inventor: Amelito H. Bonsol, Long Beach, CA (US)

Correspondence Address: Randy K. Chang, 1 Hazelnut, Irvine, CA, 92614, US

(21) Appl. No.: 11/419,099

(22) Filed: May 18, 2006

(51) Int. Cl. H05B 1/02

(52) U.S. Cl. 219/494

(57) ABSTRACT

An electrical appliance that uses electrical current to uniformly heat up cylindrical objects in a convenient compact appliance is disclosed. An electrical appliance in accordance with the present invention comprises of a housing, a heating element, and at least one cylindrical receptacle that is vertically placed along a top surface of the housing. Moreover, a heating element uniformly wraps around the cylindrical receptacle to form a heating chamber.

### BACKGROUND OF THE INVENTION

1. Field of the Invention

The present invention relates in general to an electrical appliance that uses electrical current to uniformly heat up cylindrical objects.

2. Description of the Related Art

For time immemorial, humans have struggled to find the perfect way to cook their food. Different objects require different approaches to achieve optimal cooking results, and people have struggled to come up with ways and means to optimally cook objects that do not conform to a flat cooking surface. However, cooking cylindrical objects have troubled mankind as even heat distribution is essential to optimally cooking cylindrical objects.

All the current products that are out there on the market that attempt to resolve this issue of even heat distribution while cooking cylindrical objects have taken the approach of rotational method. These common approaches to the problem referred to as rotisseries are inferior because they apply heat to a very small section of the object at a time, and it takes a significantly longer time to cook cylindrical objects in this way. Moreover, such apparatus often involve bulky rods and mechanical devices that are inconvenient for the common household.

Additionally, traditional compact appliances such as the toaster can not easily resolve the issue of cooking cylindrical object because despite its compact designs. Although appliances such as toasters take a uniform heating approach, it's shape is limited to rectangular objects. Toaster ovens on the other hand, although is capable of compensating for circular objects, can not resolve the even heat distribution problem due to their flat heating source. Appliances such as microwaves, although promotes even heat distribution, can not achieve the crisp texture that is often desirable from heating elements that offer direct heat.

It can be seen, then, that there is a need for a compact appliance that can easily resolve the need to evenly cook food objects that are cylindrical in shape. Consequently, there is a dire need for such a product that does not have the drawbacks of the common rotisserie for being slow, inefficient, and bulky.

### SUMMARY OF THE INVENTION

To minimize the limitation in the prior art, and to minimize other limitations that will become apparent upon reading and understanding the present specification, the present invention discloses an appliance for evenly cooking cylindrical food objects in a convenient compact appliance. An appliance in accordance with the present invention comprises of a housing, a heating element, and at least one cylindrical receptacle that is vertically placed along a top surface of the housing.

It is an object of the present invention to provide an appliance that will evenly cook cylindrical objects without the bulky apparatus such as a rotisserie.

### BRIEF DESCRIPTION OF THE DRAWINGS

Referring now to the drawing in which like reference numbers represent corresponding parts throughout:

FIG. 1 illustrates a complete view of the electrical appliance of the present invention.

FIG. 2 illustrates a view of the heating chamber, indicating the heating element and the position holder

FIG. 3 illustrates the an exploded view of the heating chamber, exemplifying the movement of the outer semicircle

FIG. 4 illustrates the inner details of the heating chamber by rotating the heating chambers apart from the center axis.

FIG. 5 illustrates a top view of the heating chamber, demonstrating the geometric assembly of the heating chamber

FIG. 6 illustrates the hump styles cover, demonstrating the vertically cut out grooves.

### DETAILED DESCRIPTION OF THE DRAWINGS

In the following description of the preferred embodiment, reference is made to the accompanying drawings that form a part hereof, and in which is shown by way of illustration a specific embodiment in which the invention may be practiced. It is to be understood that other embodiment may be utilized and structural changes may be made without departing from the scope of the present invention.

### Specifics of the Invention

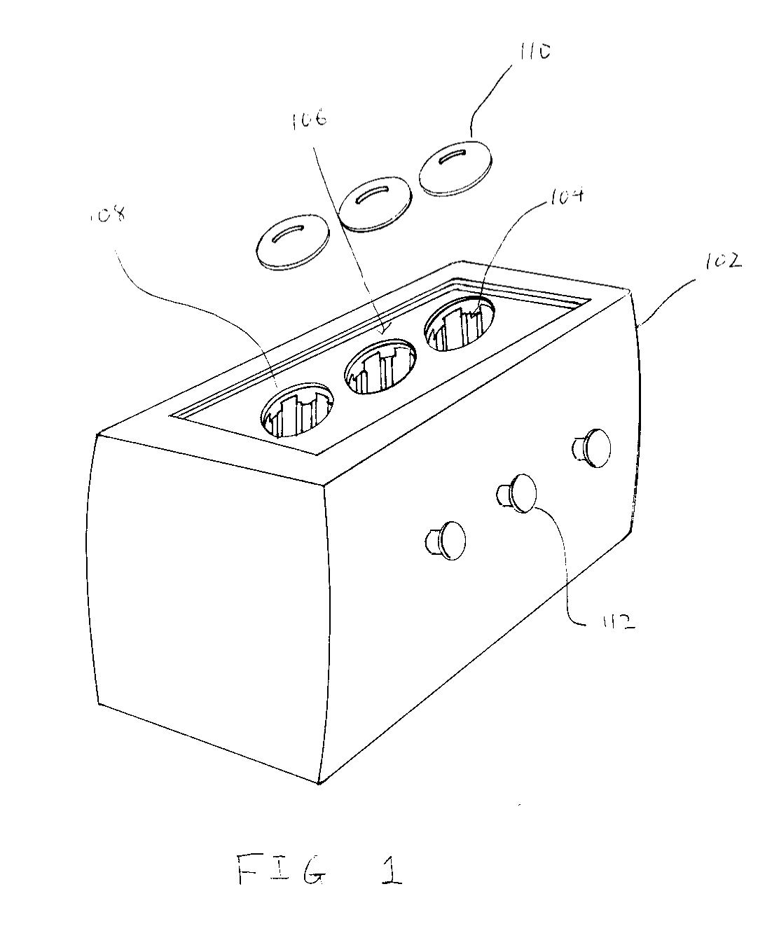

FIG. 1 illustrates an overall view of the present invention.

Electrical appliance 100 is shown in FIG. 1, with housing 102, heating element 104, and cylindrical receptacles 106 that are placed along the top surface of the housing as indicated to create a heating chamber 108. Although shown as a single unit, and, preferably, in final form comprises a single unit, electrical appliance 100 can be manufactured from several individually separate and distinct units if needed or desired.

Housing 102 is typically made into a rectangular box shaped appliance; however, it can also be round, triangular, or any other shape that is aesthetically appealing to the eye without departing from the scope of the present invention. Furthermore, although housing 102 can be made from steel, aluminum, tin, or other metals, it can be made with any other material without departing from the present invention.

Cylindrical receptacles 106 are placed vertically along top surface 106 can, and is typically used to cook corn; however, cylindrical receptacle can also be used to cook hot dogs, bread sticks, banana, and any other cylindrical objects that conform to the general shape without departing from the scope of the present invention. Furthermore, FIG. 100 indicates 3 instances of cylindrical receptacles 106; however, the number of cylindrical receptacle 106 can be any total number that can be conveniently positioned upon top surface 106 without departing from the scope of the present invention.

Hump style cover 110 is placed on top of cylindrical receptacles 106 in order to retain heat within each of the heating chamber 108. Hump style cover 110 is typically made from a ceramic material that is better at retaining heat; however, hump style cover 110 can be made from plastic, glass, or any other metal without departing from the scope of the present invention.

Movement knob 112 is placed in the front surface of electrical appliance 100 in order to allow ease of adjustment of the size of heating chamber 108. Although knob 112 is generally placed at the front surface of appliance 100, its location relative to appliance 100 is not critical, as its placement could be on the right surface, left surface, back surface, top surface, or even bottom surface without departing from the scope of the present invention.

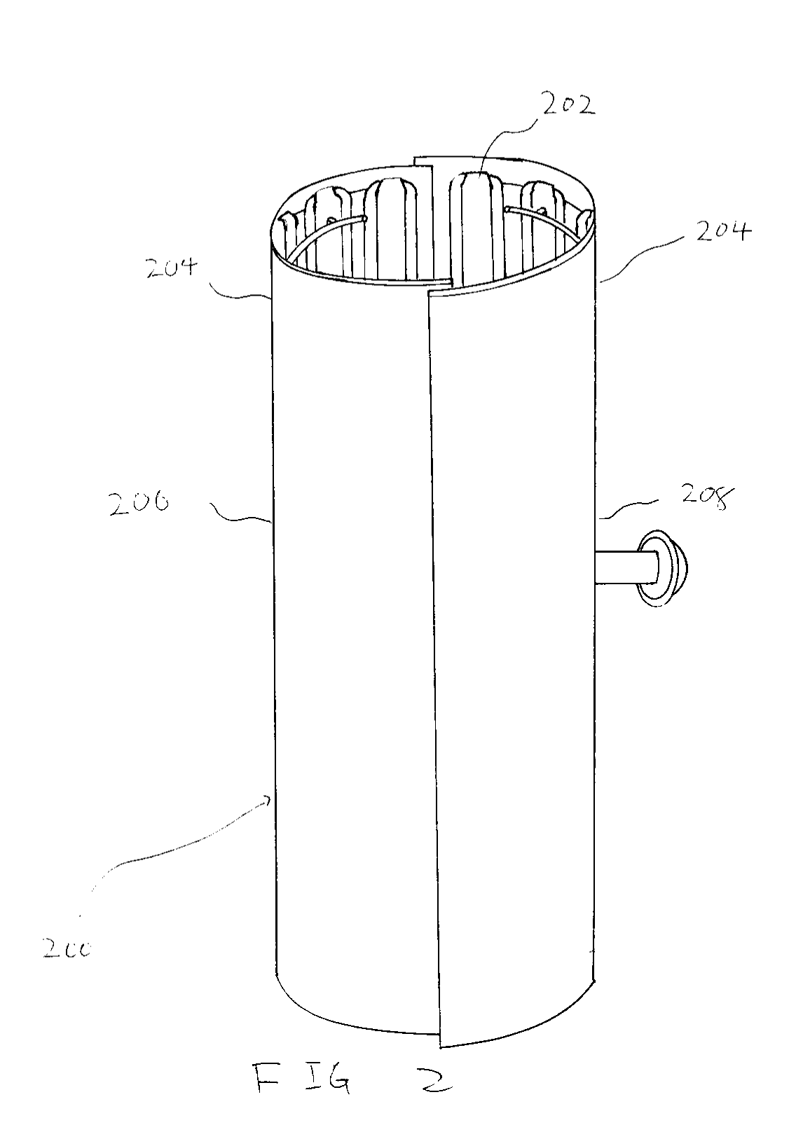

FIG. 2 illustrates an enlarged view of heating chamber 108 that is created within the cylindrical receptacle 106 shown in FIG. 1 for the purpose of further demonstrating the details of each heating chamber 108.

Heating chamber 200 as shown in FIG. 2 is the same heating chamber 108 as indicated in FIG. 1, but significantly enlarged and extrapolated from housing 100 to indicate the details of heating element 202, insulating element 204, inner semicircle 206, outer semicircle 208.

Heating chamber 200 is typically created where a heating element 202 uniformly wraps around the cylindrical receptacle 106, and although uniformity within each heating chamber is important to maintain even heat distribution, minor variations in uniformity might exist without departing from the scope of the present invention. Additionally, heating chamber 200 is created through two semicircles consisting of an inner semicircle 206, and an outer semicircle 208. The purpose of creating a cylindrical heating chamber out of two semicircles is the ability to horizontally adjust the size of the cylindrical receptacle 106 to compensate for different sizes of different objects that needs to be cooked.

Inner semicircle 206 and outer semicircle 208 are typically formed to each consist half of a circular shape, however, the shapes of the inner semicircle 206, and outer semicircle 208 need not be limited to such a circular shape, and can be oval, hexagonal, octagonal, or any other shape that can be symmetrically separated down the middle without departing from the scope of the present invention.

Heating element 202 is typically made up of any metal of high resistance to generate heat through electrical current; however, heating element can be made out of michrome, nichrome, nickel-chromium, or any other material that could generate heat without departing from the scope of the present invention.

Insulating element 204 encompasses the heating element to retain heat within each of the heating chamber 200 in order to maintain the high temperature. Although insulating element 204 is typically made out of ceramic materials that are known for insulating heat; insulating element can also be made out of plastic, metal, or any other material that has low coefficient of heat transfer without departing from the scope of the present invention.

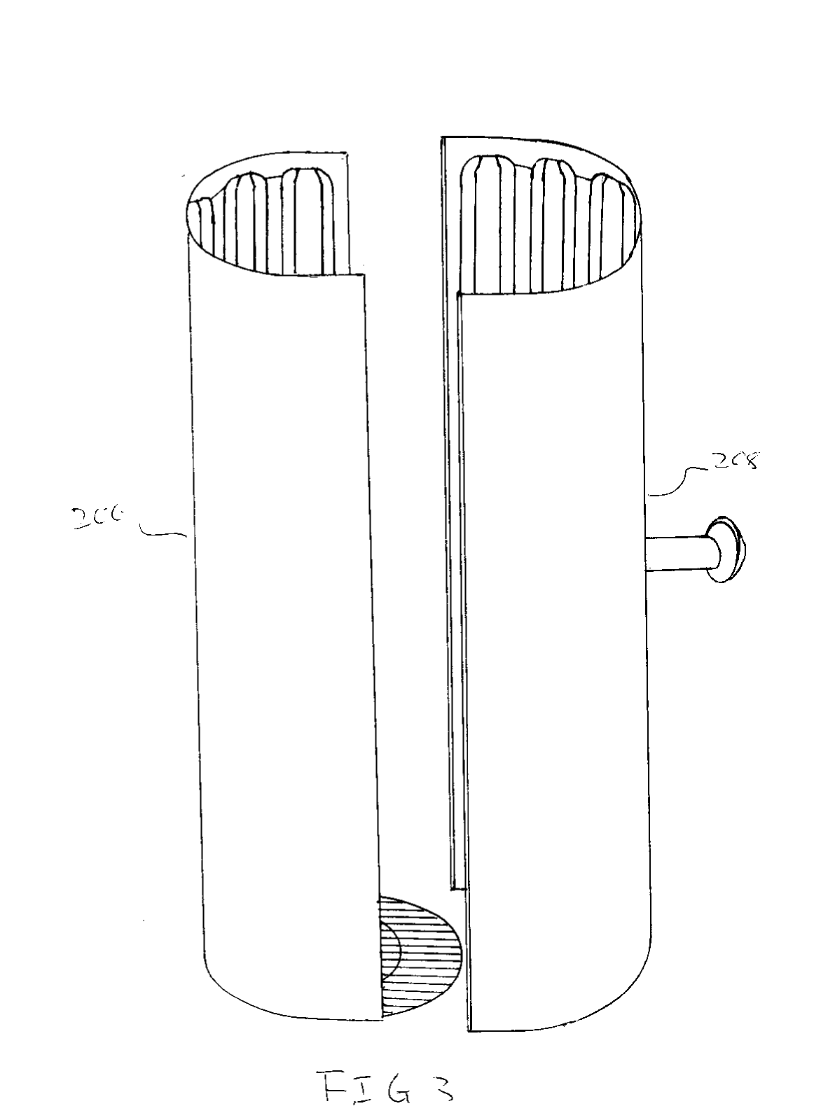

FIG. 3 illustrates an exploded view of heating chamber 108 that is created within the cylindrical receptacle 106 shown in FIG. 1. The exploded view offered by FIG. 3 shows the horizontal movement of outer semicircle, and the internal components of heating chamber 108.

Heating chamber 300 as shown in FIG. 3 is the same heating chamber 108 as indicated in FIG. 1 and heating chamber 200 in FIG. 2, but outer semicircle 208 have been moved to its expanded position to better show horizontal movement.

Although the present invention keeps inner semicircle 206 stationary, and outer semicircle 208 is movable, the inner semicircle could be movable while keeping the outer semicircle 208 stationary without departing from the scope of the present invention. Furthermore, although the joining of the inner semicircle 206 and the outer semicircle 208 is through horizontal movement, other movements such as transverse movement, diagonal movements, and any other movements used to compensate for different sizes of the object being cooked can be utilized without departing from the scope of the present invention.

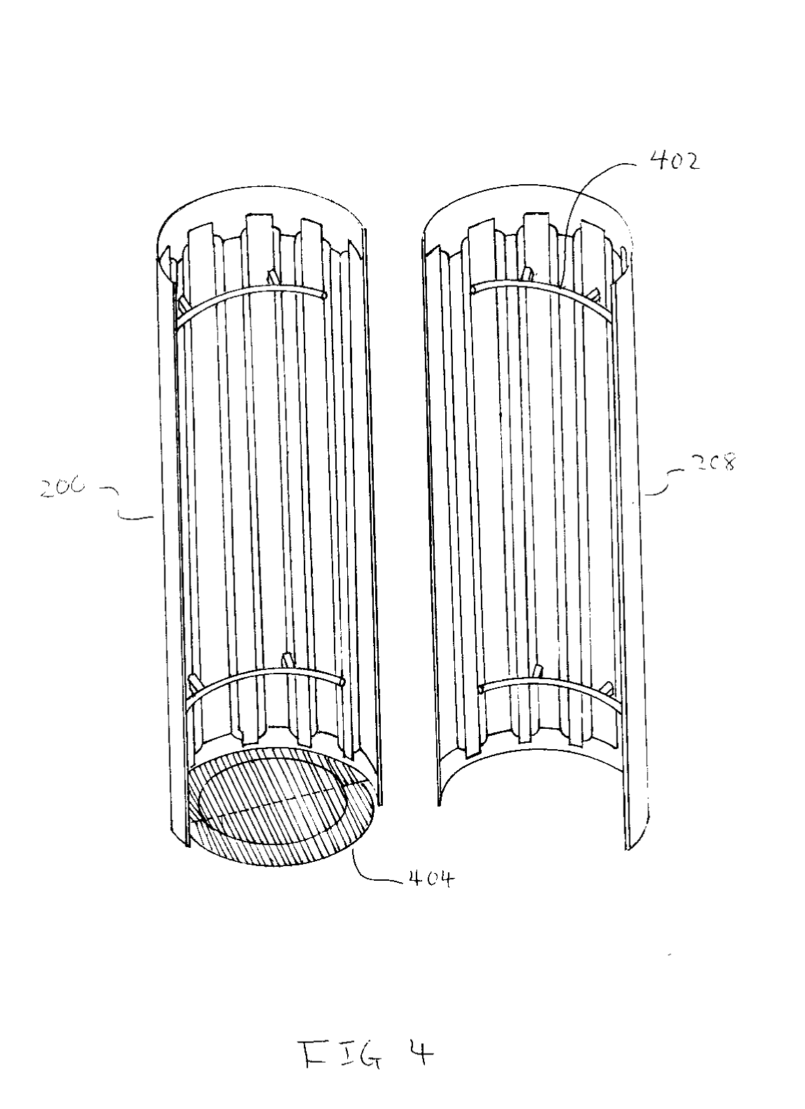

FIG. 4 illustrates the inner workings of heating chamber 108 by rotating inner semicircle 206 and outer semicircle 208 apart from each other to allow better illustration. This rotational view offers additional insight to the location of position holder 402 and the existence of bottom stopper 404.

Here the figure illustrates two instances of position holder 402, with one placed near the top of heating chamber 108 and the other one placed near the bottom of heating chamber 108. Although no more than two instances of position holder 402 is needed to maintain stability of the object being inserted into heating chamber 108, the number of instances of position holder could be reduced to one, or increased to three, four, five, or any number of instances without departing from the scope of the current invention. Additionally, despite the fact that stability is generally maximized when the position holders 402 be placed near the top and bottom of heating chamber 108, its location could be at any position inside the heating chamber without departing from the scope of the current invention.

Bottom stopper 404 here is shown to be attached to bottom of inner semicircle 206, because inner semicircle 206 is generally maintained in a stationary position; and the movement of a lighter outer semicircle is desirable. However, bottom stopper 404 could be attached to outer semicircle 208 without departing from the scope of the current invention. The existence of bottom stopper 404 is used to stop the object being inserted from falling through heating chamber 108, and to maintain the vertical position of the object being inserted to ensure optimal heating. Additionally, bottom stopper 404 here is made out of a crossed sectional wired mesh material to ensure that the crumbs and other cooking residues fall though the heating chamber into a crumb tray.

Although a wired mesh material being used for bottom stopper 404 is the preferred embodiment, the usage of horizontal wires, vertical wires, or any other material that allows the passage of fine particles could be used without departing from the scope of the current invention. Moreover, although it is desirable to have bottom stopper 404 be made out of a material that allows the fine particles to fall though for ease of cleaning and maintenance, bottom stopper 404 could be a solid bottom without departing from the scope of the current invention.

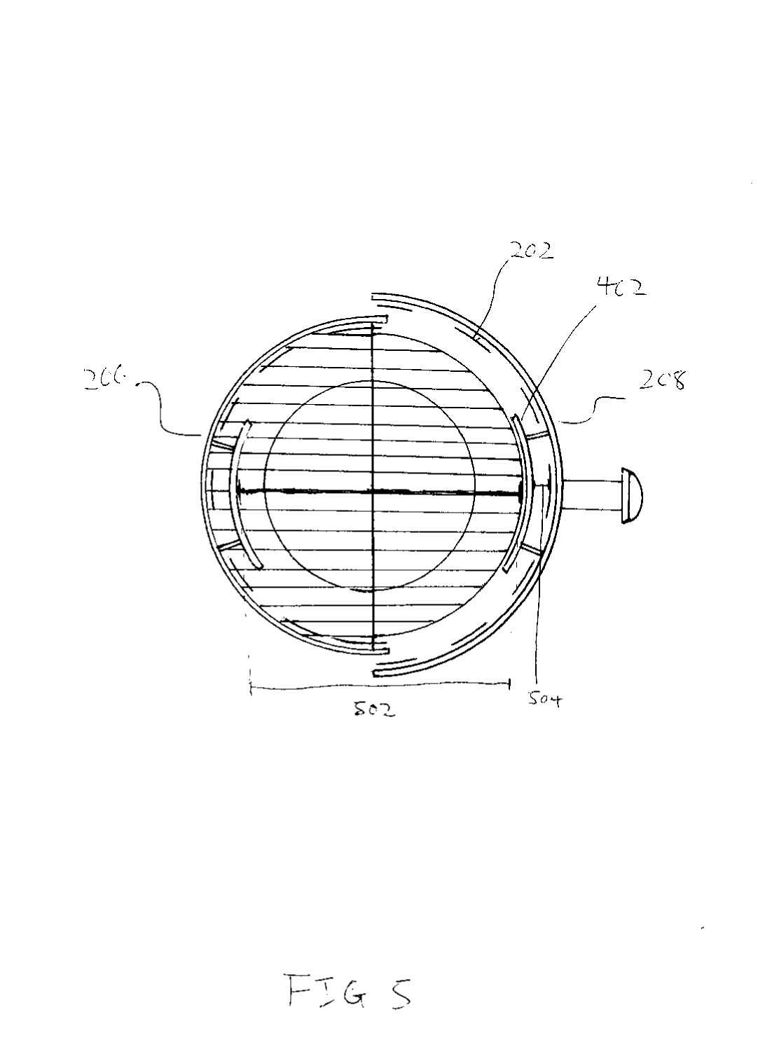

FIG. 5 illustrates a top view of heating chamber 108 that is created within the cylindrical receptacle 106 as shown in FIG. 1. The top view offers additional insight to the assembly of inner semicircle 206 and outer semicircle 208 as well as the special relation between position holder 402 and heating element 202.

Heating chamber 108 is shown here as a single assembled unit with an inner semicircle 206 and outer semicircle 208 assembled together. The inner semicircle 206 seems to have a smaller diameter than outer semicircle 208, and that difference is essential to the proper assembly of heating chamber 108. Although a slight difference in the diameter between inner semicircle 206 and outer semicircle 208 is critical to functionality, the exact difference can be any numerical distance without departing from the scope of the present invention. Moreover, although inner semicircle 206 has a smaller diameter than outer semicircle 208, the diameters could be reversed without departing from the scope of the current invention yielding an inner semicircle 206 having a larger diameter than outer semicircle 208.

Position holder 402 is used as a separation between heating element 202 and the object being cooked. An inner diameter 502 is created when the position holder is placed an equal distance away from heating element 202, and inner diameter 502 limits the outermost surface area of the object being cooked. Position holder 402 is generally made out of a non-heat-conductive material such as ceramic; however, it can be metal, plastic or any other material that will not burn the object being cooked without departing from the scope of the present invention.

In order to ensure maximum heat exposure, the distance of separation 504 created by position holder 402 between heating element 202 and inner diameter 502 should be kept to a minimal. Although a distance of 2 millimeter is recommended for distance of separation 504, any distance of separation can be utilized without departing from the scope of the present invention.

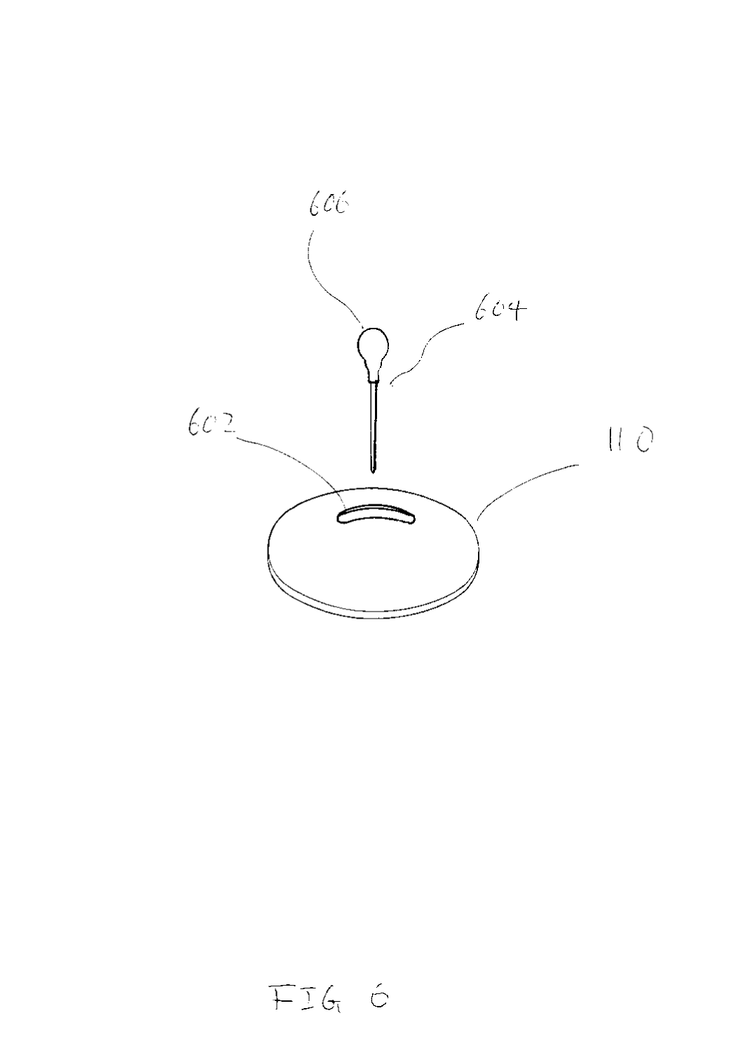

FIG. 6 illustrates an enlarged view of the hump styled cover 110 with cut out grooves 602, and piercing rob 604, and handles 606.

As shown, the humped styled cover 110 contains vertically cut grooves 602 used to compensate for the directional variations of the object that is being inserted into cylindrical receptacle 106. The vertically cut grooves work in conjunction with piercing rod 604 to ensure that the object inserted stays vertical within heating chamber 108. Moreover, piercing rod 604 can also serve the purpose of creating a handle that is easy to grasp when removing food objects that has been heated.

Piercing rod 604 is generally a rod that is sharp on one end to allow for easy piercing of the object being cooked. The existence of a piercing rod 604 allows for ease of handling of the object, and however, it is not essential to the functionality of appliance 100 to have a piercing rod 604, and its lack of existence will not depart from the scope of the present invention. Piercing rod 604 is typically made of a hard durable metal material; however, piercing rod 604 can be plastic, wood, or any other material that is durable to withstand the rigors of multiple piercing thrusts. Moreover, piercing rod 604 usually contains a handle 606 to allow an easy grip of piercing rob 604, however, handle 606 is not essential to the functionality of piercing rod 604, and it's lack of existence will not depart from the scope of the present invention.

### CONCLUSION

In summary, the present invention provides for evenly cooking cylindrical food objects in a convenient compact appliance. An appliance in accordance with the present invention comprises of a housing, a heating element, and at least one cylindrical receptacle that is vertically placed along a top surface of the housing.

The foregoing description of the preferred embodiment of the invention has been presented for the purpose of illustration and description. It is not intended to be exhaustive or to limit the invention to the precise form disclosed. Many modifications and variations are possible in light of the above teaching. It is intended that the scope of the invention not be limited by this detailed description, but only by the claims and the equivalents to the claims appended hereto.

What is claimed is:

1. An electrical appliance comprising
a. A housing;
b. A heating element; and
c. A at least one cylindrical receptacle that is vertically placed along a top surface of the housing

2. the electrical appliance of claim 1, where a heating element which uniformly wraps around the cylindrical receptacle to form a heating chamber.

3. the electrical appliance of claim 2, wherein the heating chamber is composed of an inner semicircle and an outer semicircle that are joined together to conform to the shape of the cylindrical receptacle creating an inner diameter.

4. the electrical appliance of claim 3, wherein a position holder is used within each of the heating chamber creating separation between the inner diameter of the heating chamber and the heating element to avoid direct contact with the heating element.

5. the electrical appliance of claim 4, wherein the outer semicircle is horizontally movable to enlarge or reduce the inner diameter of the heating chambers to compensate for different sizes of an object being inserted

6. the electrical appliance of claim 5, wherein each of the heating chamber will contain a hump style cover that is removably mounted on the cylindrical receptacles

7. the electrical appliance of claim 1, wherein the electrical appliance is used for corn

8. the electrical appliance of claim 7, where a heating element which uniformly wraps around the cylindrical receptacle to form a heating chamber.

9. the electrical appliance of claim 8, wherein the heating chamber is composed of an inner semicircle and an outer semicircle that are joined together to conform to the shape of the cylindrical receptacle creating an inner diameter.

10. the electrical appliance of claim 9, wherein a position holder is used within each of the heating chamber creating separation between the inner diameter of the heating chamber and the heating element to avoid direct contact with the heating element.

11. the electrical appliance of claim 10, wherein the outer semicircle is horizontally movable to enlarge or reduce the inner diameter of the heating chambers to compensate for different sizes of an object being inserted

12. the electrical appliance of claim 11, wherein each of the heating chamber will contain a hump style cover that is removably mounted on the cylindrical receptacles

13. the electrical appliance of claim 12, wherein the hump style covers contain a vertically cut out grooves to compensate for directional variations of the handle of the object being inserted

14. the electrical appliance of claim 13, wherein an insulating element encompass the heating element to retain heat within each of the heating chamber

15. the electrical appliance of claim 14, wherein the heating element generates heat through the passage of a electrical current through a metal of high resistance

16. An electrical appliance comprising
a. A housing;
b. A at least one cylindrical receptacle; and
c. A heating element which uniformly wraps around the cylindrical receptacle to form a heating chamber.

17. an electrical appliance of claim 16, wherein the heating chamber is composed of an inner semicircle and an outer semicircle that are joined together to conform to the shape of the cylindrical receptacle creating an inner diameter.

18. an electrical appliance of claim 17, wherein a position holder is used within each of the heating chamber creating separation between the inner diameter of the heating chamber and the heating element to avoid direct contact with the heating element.

19. an electrical appliance of claim 18, where a heating element which uniformly wraps around the cylindrical receptacle to form a heating chamber.

20. an electrical appliance of claim 19, wherein the outer semicircle is horizontally movable to enlarge or reduce the inner diameter of the heating chambers to compensate for different sizes of an object being inserted
